(19) United States
(12) Patent Application Publication
(10) Pub. No.: US 2015/0250327 A1
(43) Pub. Date: Sep. 10, 2015

(54) System and Method of Calibrating a Mattress

(71) Applicants: Dennis M. Boyd, St. Louis, MO (US); Carla Williams, St. Louis, MO (US)

(72) Inventors: Dennis M. Boyd, St. Louis, MO (US); Carla Williams, St. Louis, MO (US)

(21) Appl. No.: 14/713,155

(22) Filed: May 15, 2015

Related U.S. Application Data
(63) Continuation-in-part of application No. 14/309,885, filed on Jun. 19, 2014.
(60) Provisional application No. 61/837,243, filed on Jun. 20, 2013.

(51) Int. Cl. A47C 27/08; A47C 27/14; G06Q 30/06; A47C 27/10

(52) U.S. Cl. CPC A47C 27/08; A47C 27/085; A47C 27/081; A47C 27/10; A47C 27/142; G06Q 30/0631

(57) ABSTRACT

A method and system is provided for calibrating a mattress having a fluid filled cell to in part provide support for the mattress. A database has data about support characteristics of the mattress depending upon an amount of fluid in the fluid filled cell. The fluid may be air or water. A server is configured for communication with the database and a client computer via a network. The server includes a memory in which an application is stored. The application comprises a user sleep characteristic processing module and a mattress calibration calculation module. The server may receive user sleep characteristic data, and based thereon, access the database to retrieve mattress calibration data and communicate the mattress calibration data to the client computer.

### CROSS-REFERENCE TO RELATED APPLICATIONS

This patent application is a continuation-in-part to application Ser. No. 14/309,885, filed on Jun. 19, 2014, currently pending, which claims the benefit of provisional application Ser. No. 61/837,243, filed Jun. 20, 2013, the disclosures both of which are incorporated herein.

### BACKGROUND

The present disclosure relates to adjustable mattresses and systems for calibrating or setting adjustable mattresses in accordance with a user's sleep characteristics. In one embodiment, the mattress may comprise an air mattress with one or more air chambers for each user of the mattress. For instance, a double, queen or king size air mattress may have two users, and the portion of the mattress used by each user may have one or more air chambers. The systems described herein may allow one or more users to calibrate, define, or set the recommended air pressure in each chamber of the user's portion of the mattress in accordance with the user's sleep characteristics.

In another embodiment, the mattress may comprise a hybrid foam mattress as disclosed in the parent application. As described in more detail below, the hybrid foam mattress comprises a foam body having a top surface. A plurality of slits may extend across the top surface of the foam body to divide the top surface into a plurality of adjacent slats. There may be at least one elongate chamber extending through the body, generally parallel to and generally aligned with each slit. At least one filled-cell is disposed in at least one of the elongate chambers to support at least one slat. The fluid filled cells may each comprise an elongate flexible envelope, with a recloseable opening for adding fluid to the envelope. The fluid-filled cells can contain gas (such as air), liquid (such as water), gel, and/or foam. The fluid-filled cells preferably have specified firmness fill levels indicated on the exterior of the envelope. There is preferably at least one fluid cell in each chamber, but there could be two or more. The fluid-filled cells can have the same or a different cross sectional shape than the chamber in which they are disposed. The fluid-filled cells can have different fluid fill levels, providing different levels of support of the mattress surface. In accordance with aspects of the disclosure, a system and method of filling the at least one fluid filled-cell is provided to allow the user to calibrate, define, or set the user's portion of the mattress in accordance with the user's sleep characteristics.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic diagram of a preferred embodiment of a mattress constructed in accordance with the principles of this invention;

FIG. 2 is a perspective view of a foam body comprising part of the mattress of the preferred embodiment;

FIG. 3 is a side elevation view of the foam body;

FIG. 4 is an end elevation view of the foam body;

FIG. 5 is a top plan view of the foam body;

FIG. 6 is an enlarged partial side elevation view of the foam body, showing the slits and the chambers;

FIG. 7 is a schematic diagram of an alternate construction of the preferred embodiment;

FIG. 8 is a schematic diagram of a second alternate construction of the preferred embodiment; and

FIG. 9 is a schematic diagram of a third alternate construction of the preferred embodiment.

FIG. 10 shows an implementation of one embodiment of a mattress calibration system comprising a networked client-server system in wherein a user may access mattress calibration application that is configured to accept the user's sleep characteristics and generate mattress calibration information.

FIG. 11A-11F depicts example data structures for mattress calibration data in accordance with an example embodiment.

FIG. 12 depicts an example arrangement for an application to be executed by a client computer in accordance with an example embodiment.

FIGS. 13-14 depict examples of graphical user interfaces (GUIs) for display on a client computer generated by the mattress calibration application which allow the user to input data related to the user's sleep characteristics.

FIGS. 15-28 depict examples of graphical user interfaces (GUIs) for display on a client computer generated by the mattress calibration application which display for the user calibration information.

Corresponding reference numerals indicate corresponding parts throughout the several views of the drawings.

### DETAILED DESCRIPTION

Example embodiments will now be described more fully with reference to the accompanying drawings.

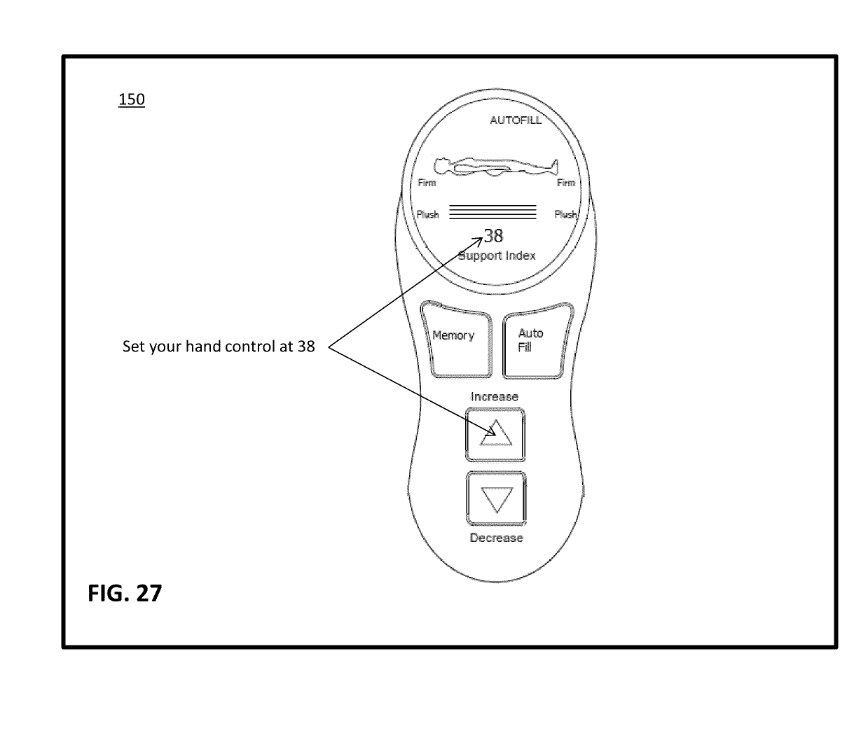

By way of example and not in any limiting sense, one example of a mattress which may be used in accordance with the principles of this invention is a two chamber air mattress provided by Boyd Specialty Sleep, of St. Louis, Mo., under the trademarks NIGHT AIR, SPLENDOR, SILENT NIGHT, and LUXAIRE. In the two chamber air mattress, each side of the mattress may be adjusted separately from the other. A hand control may selectively operate an air pump to adjust the air pressure for the chamber on each side of the mattress. A depiction of an exemplary hand control is shown in FIG. 27. Each side of the mattress may have its own control. The hand control may be configured to allow adjustment in single digit increments from 1 to 100.

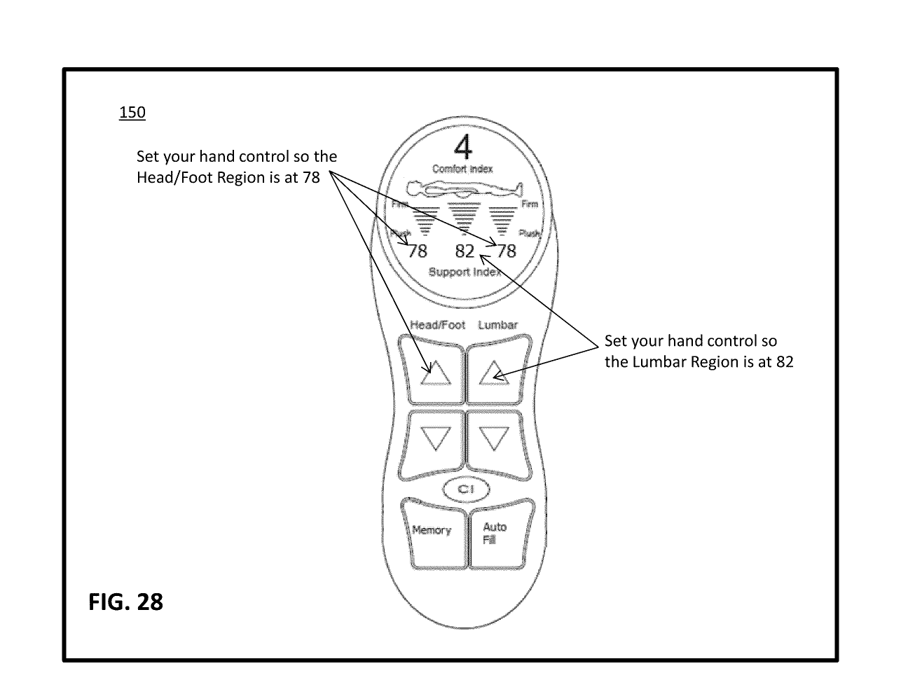

By way of example and not in any limiting sense, another example of a mattress which may be used in accordance with the principles of this invention is a six chamber air mattress provided by Boyd Specialty Sleep, of St. Louis, Mo., under the trademarks NIGHT AIR, STARDUST, OPERETTA, and COMET. In the six chamber air mattress, six separate areas of the mattress may be adjusted. For instance, on each side of the mattress, the head and legs region may be adjusted separately from the lumbar region. A hand control may selectively operate an air pump to adjust the head and foot regions together, and the lumbar region. A depiction of an exemplary hand control is shown in FIG. 28. A hand control may be provided for the zones on each side of the mattress. The hand control may be configured to allow adjustment in single digit increments from 1 to 100.

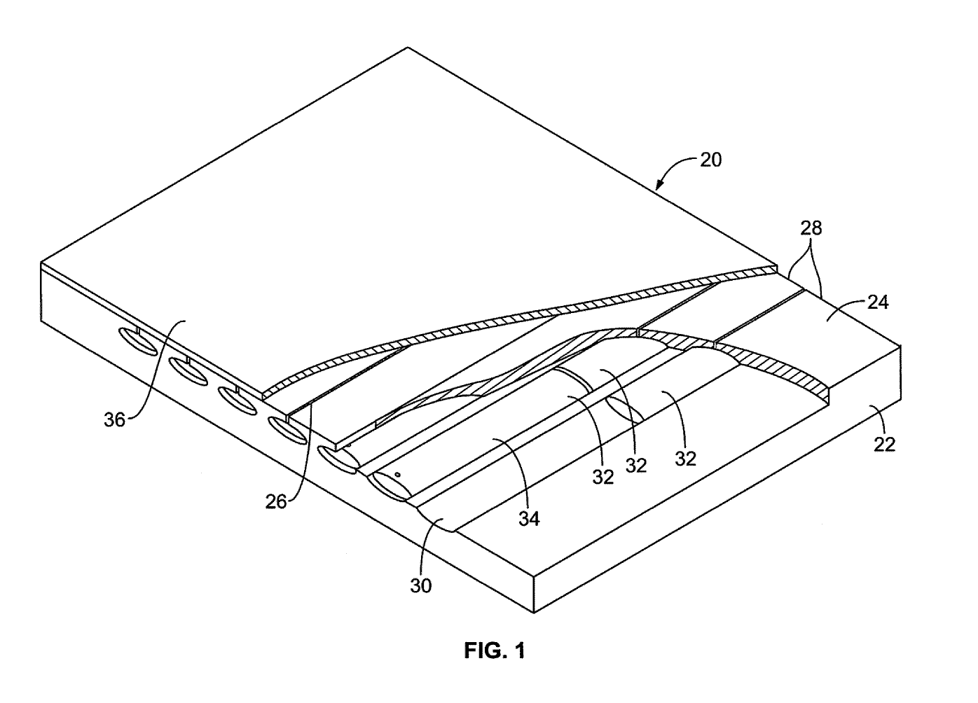

By way of example and not in any limiting sense, another example of a mattress which may be used in accordance with the principles of this invention is indicated generally as 20 in FIG. 1. The mattress 20 is adapted for use on a box spring or other conventional bed support, to provide comfortable support of a person while resting or sleeping. The mattress 20 may comprise a foam body 22 having a top surface 24. The top surface may comprise a mattress topper. A plurality of slits 26 may be provided and extend across the top surface 24 of the foam body 22. The slits may divide the top surface into a plurality of adjacent slats 28. The slits may be formed as channels into the foam body. In addition to or in the alternative, the mattress may be provided with at least one elongate chamber 30 extending through the body 22. The at least one chamber 30 may be arranged generally parallel to and generally aligned with each slit 26. At least one filled-cell 32 may disposed in at least one of the elongate chambers 30. When the mattress is provided with slits extending across the top, the at least one of the elongate chambers 30 may support at least one slat 28.

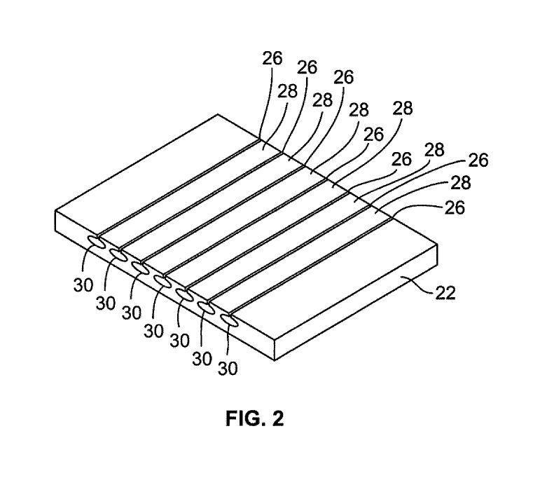

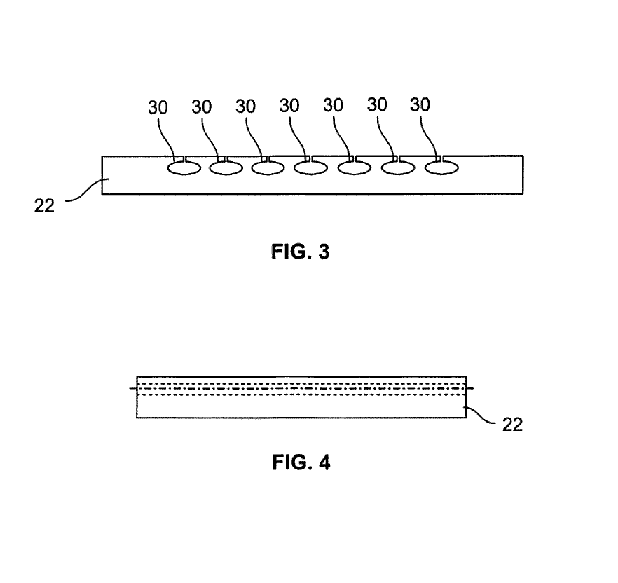

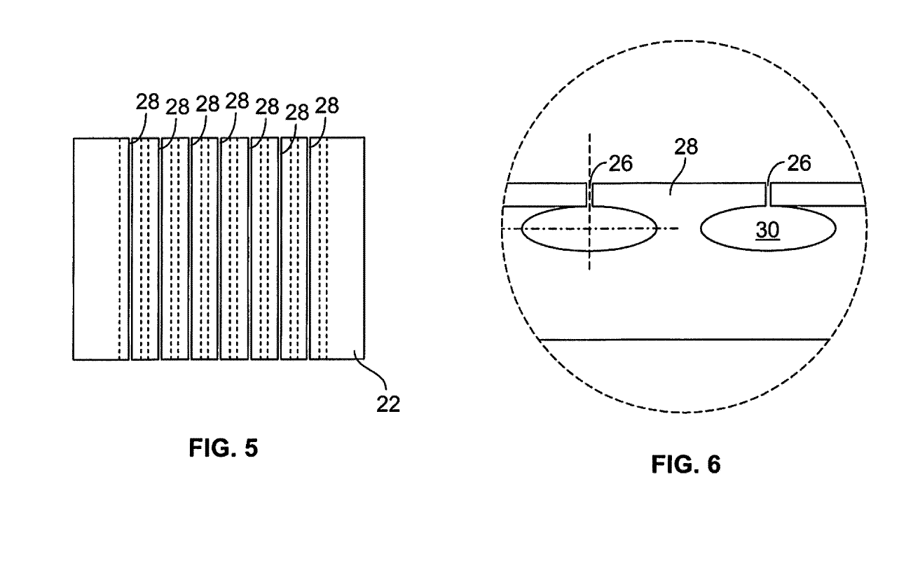

As shown in FIGS. 1 and 2, the foam body 22 is preferably a rectangular prism having a length, a width, and a thickness. The foam body 22 could of course be some other shape, such as disc shaped if desired. The slits 26 preferably extend across the width of the foam body, dividing the top surface 24 into a plurality of adjacent slats 28 across the length of the foam body 22. Alternatively the slits could extend across the length of the foam body, dividing the top surface into a plurality of adjacent slats across the width of the foam body. As discussed above, the mattress may be provided without slits and access to the chambers in the mattress may be gained from sides of the mattress. Alternatively, the slit may form a T-shape in the top of the mattress body or may be in the form of a channel, which forms a U-Shape in the mattress body that may encompass the at least one chamber. A foam section may be inserted in the slit to form a continuous top surface for the mattress. In addition or alternative to, a mattress topper or portion thereof may form the top surface of the mattress and cover the slit and at least one chamber.

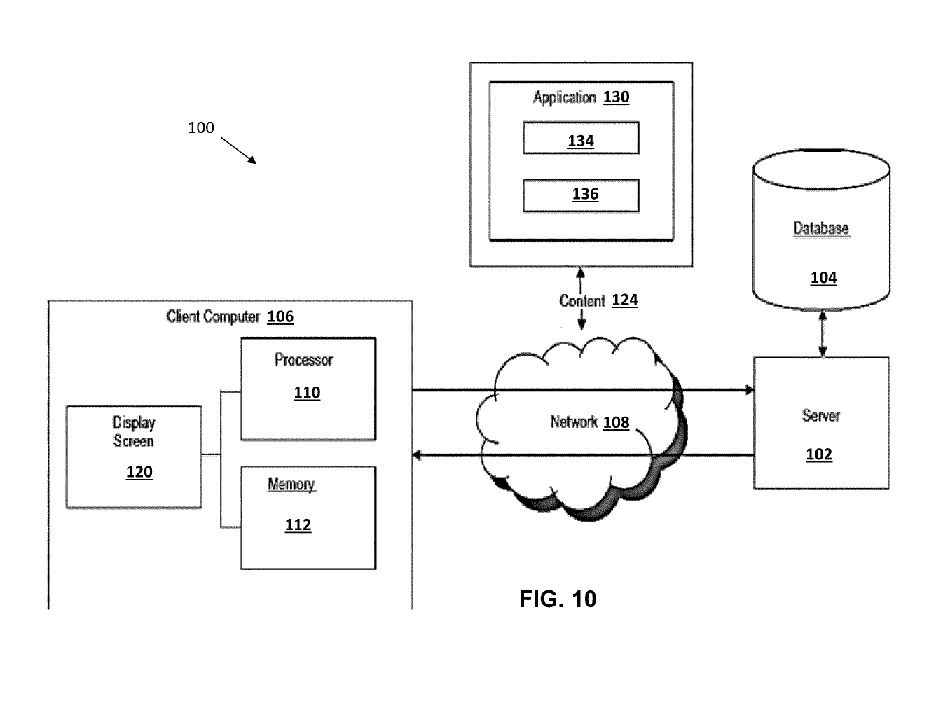

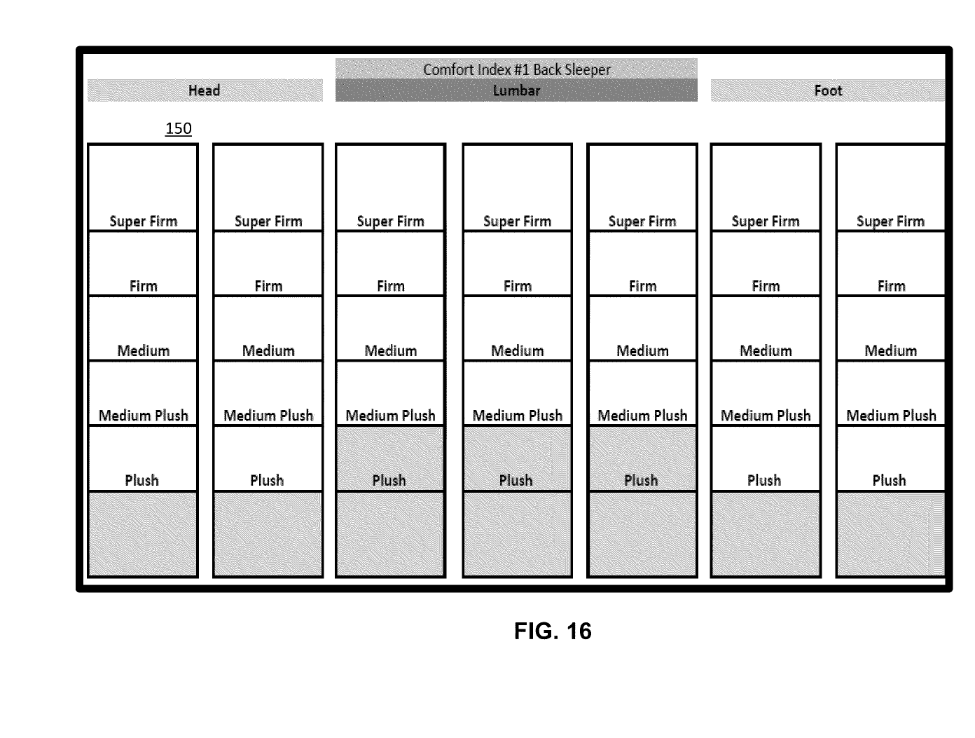

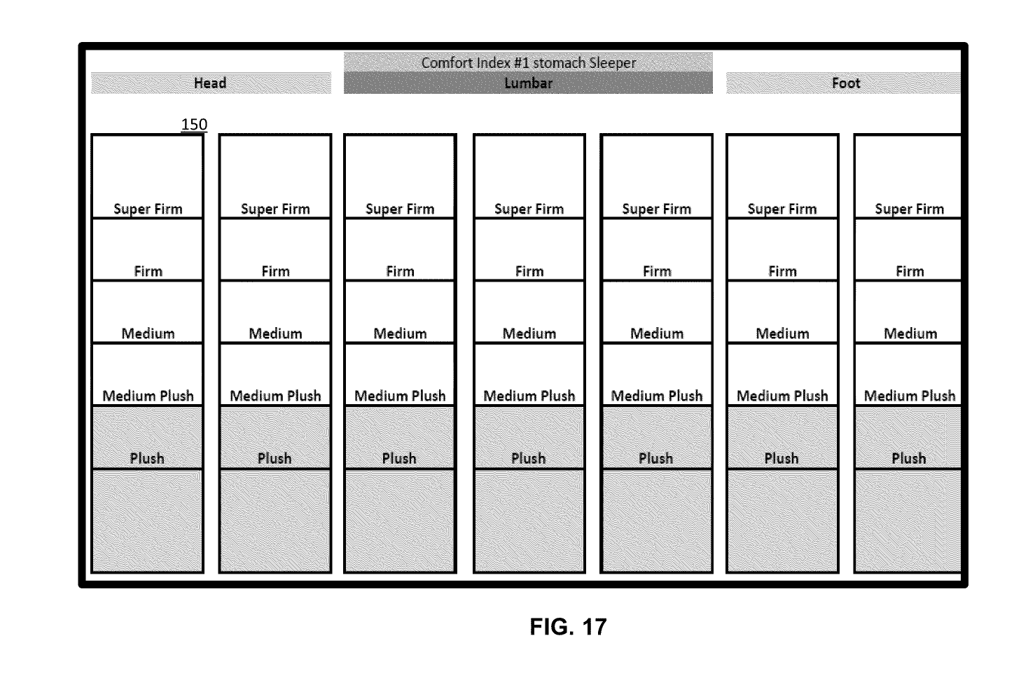

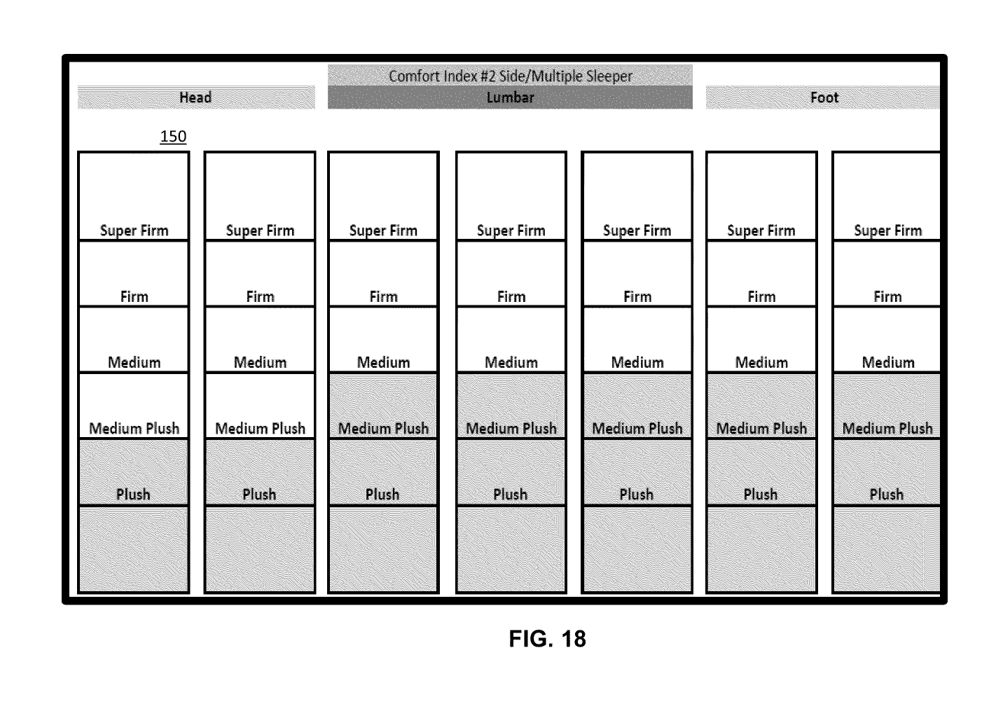

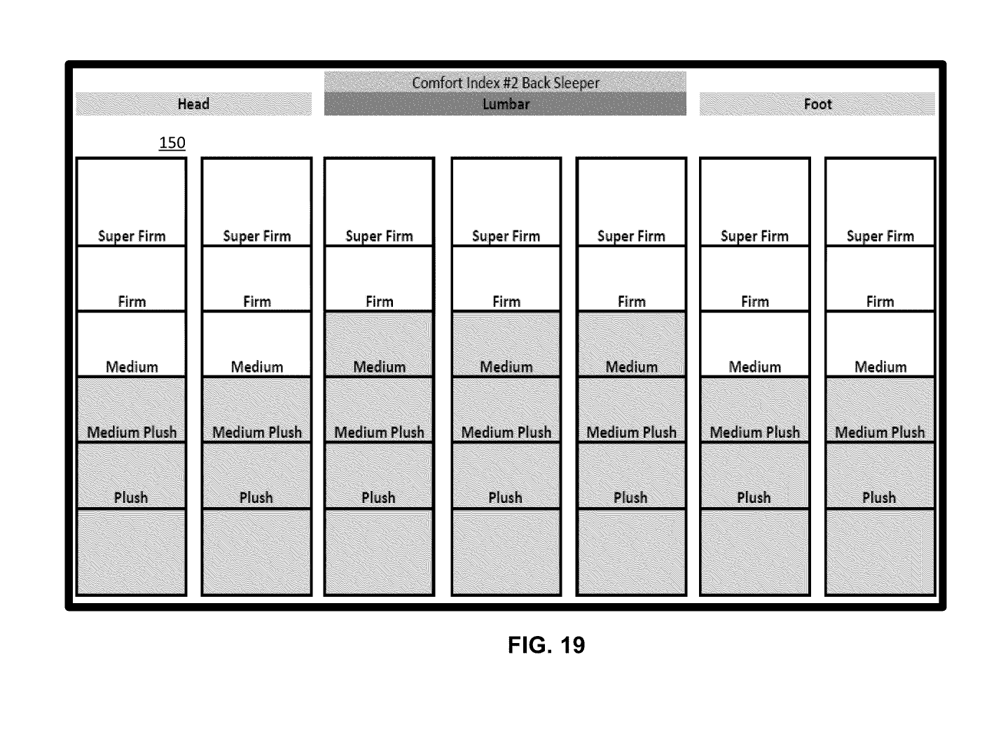

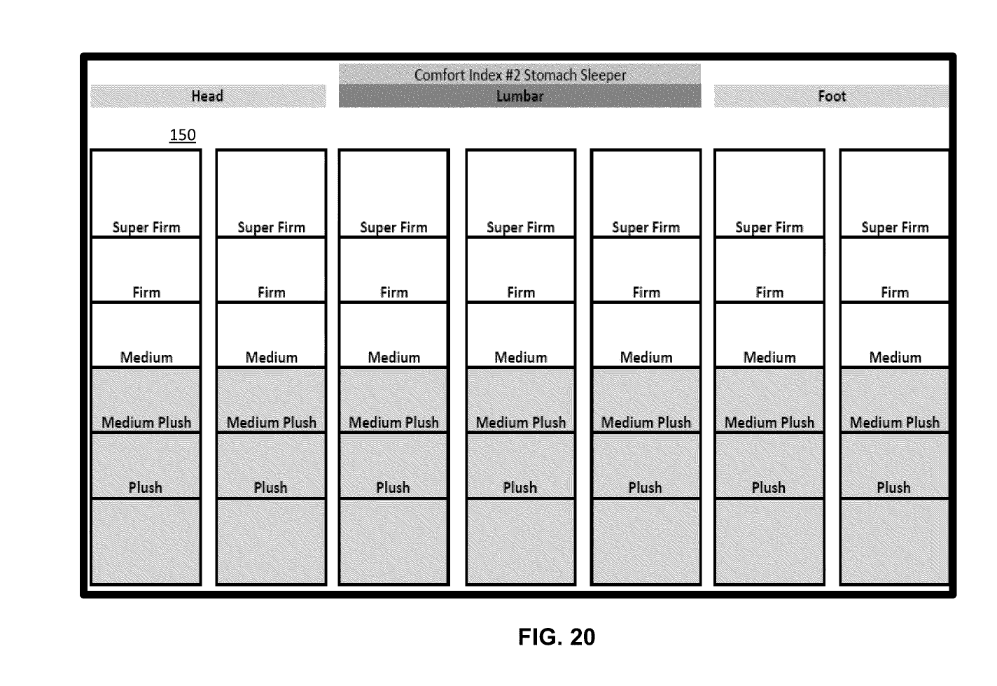

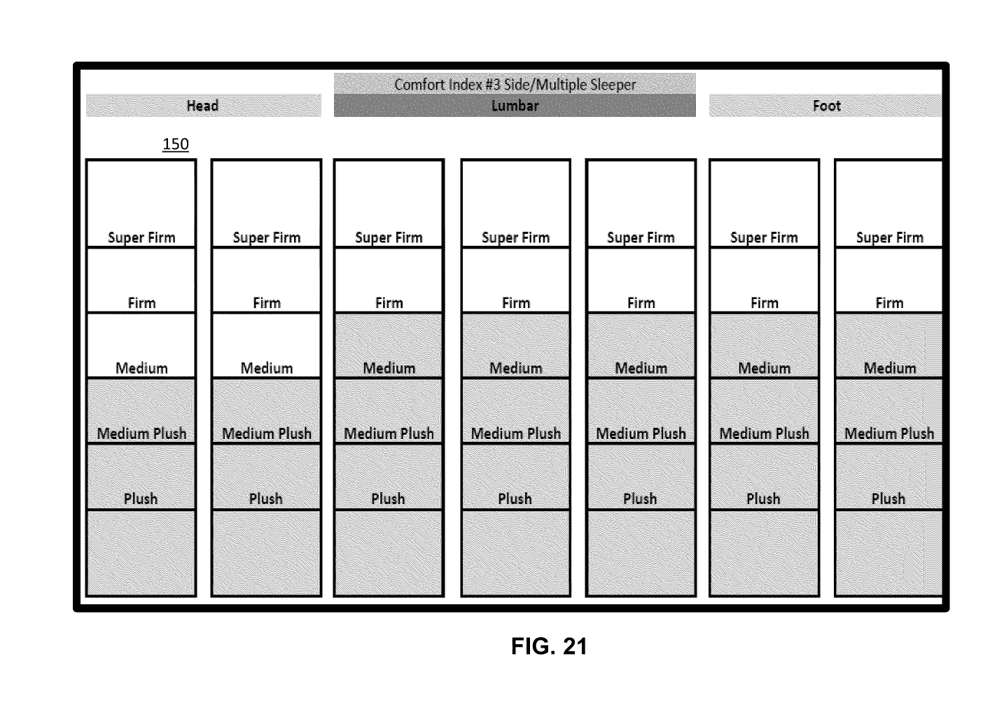

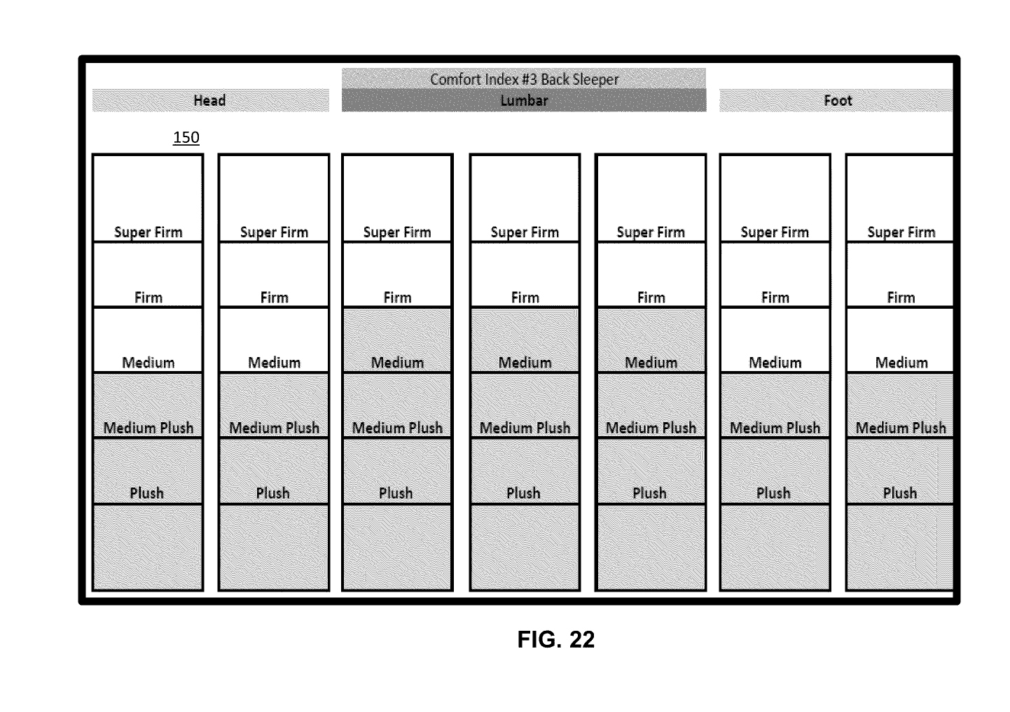

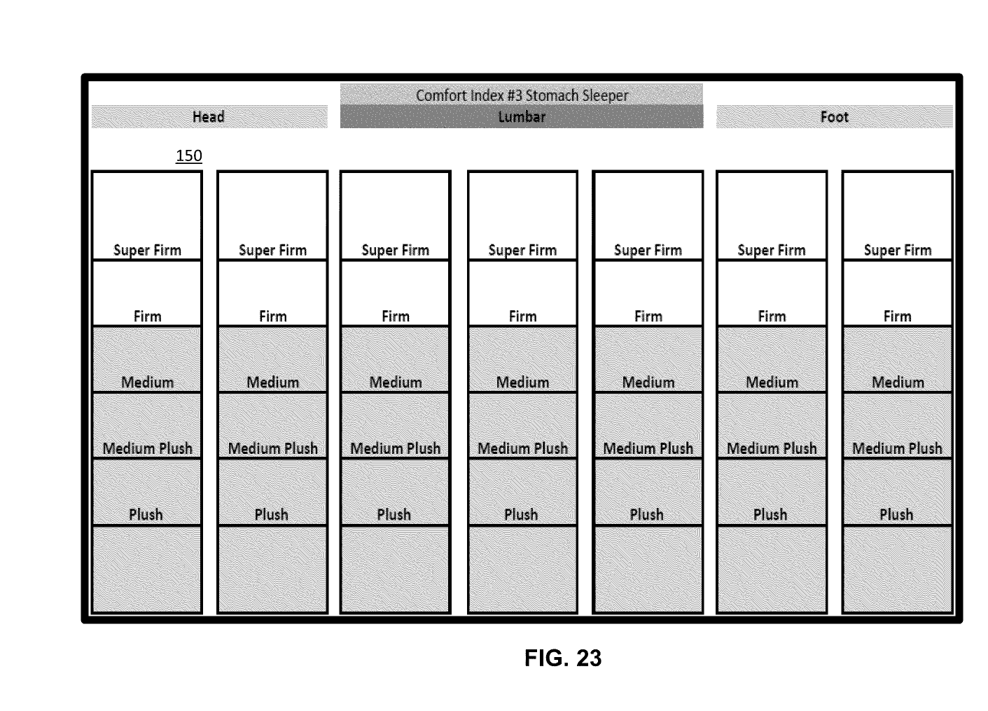

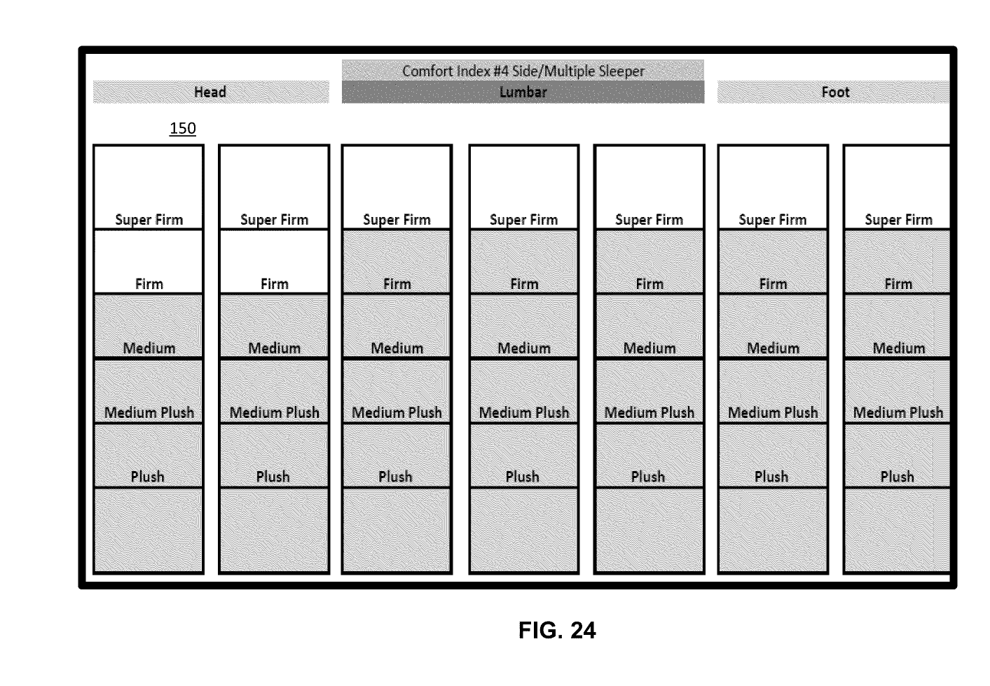

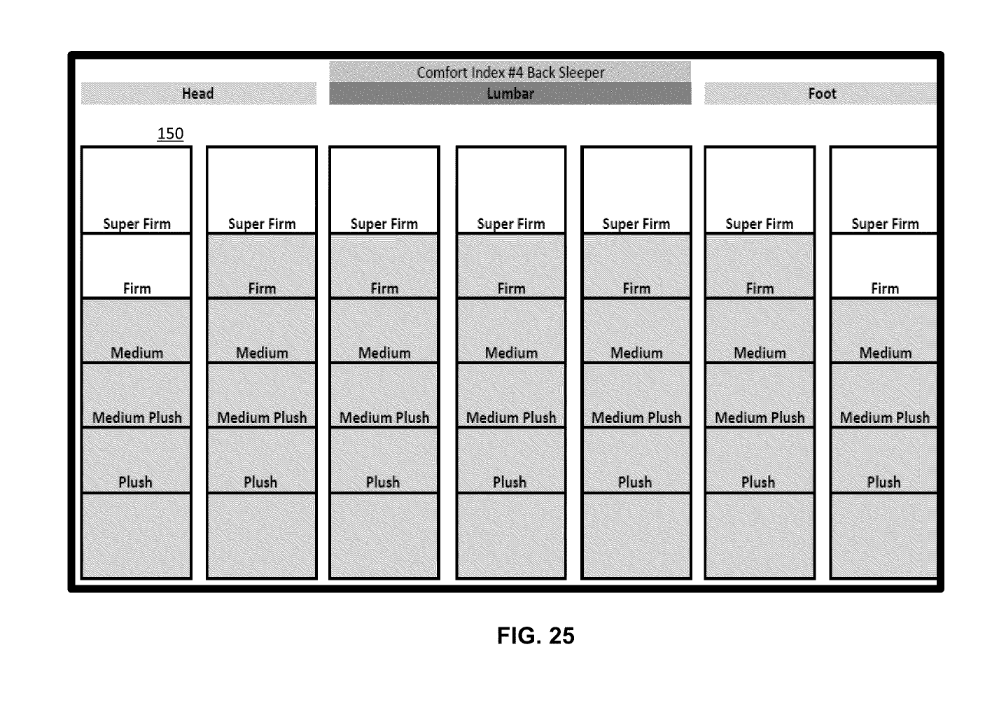

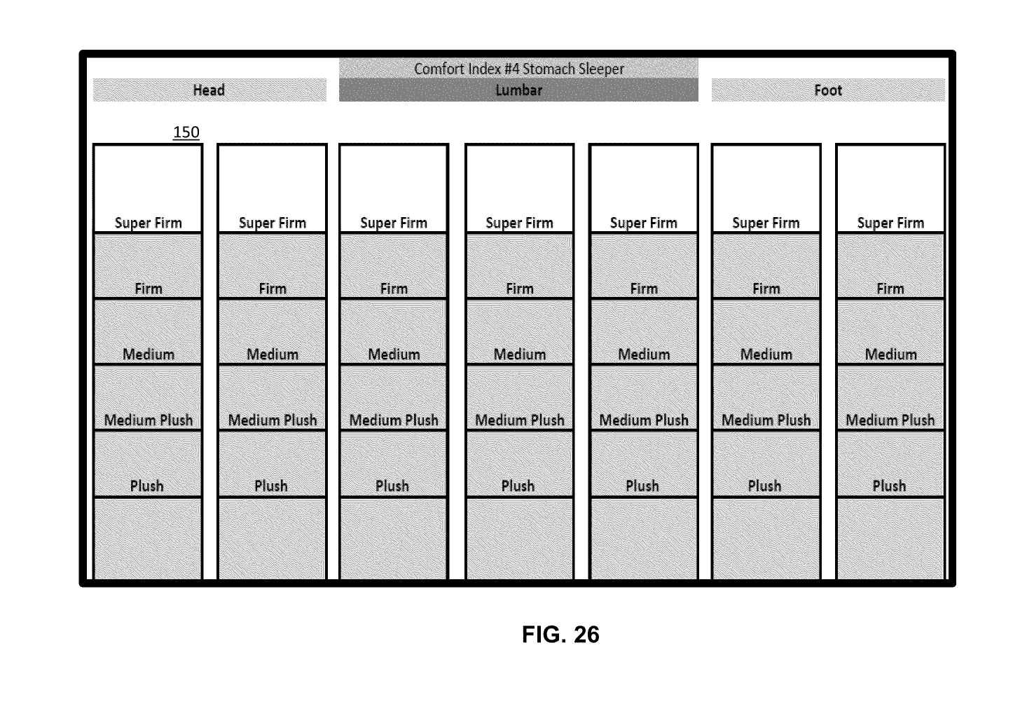

The fluid filled cells 32 preferably each comprise an elongate flexible envelope 34, with a recloseable opening (not shown) for adding fluid to the envelope. The fluid-filled cells 32 can contain gas (e.g., air), liquid (e.g., water), gel, foam, and or particles. Suitable gels can have a wide range of properties, including rheological properties heat absorption and heat conduction properties. Similarly, suitable foams can have a wide range of properties, and can include polyurethane foams, latex foams, and viscoelastic foams (so-called “memory foams”), of various densities and IFD. The flexible envelopes 34 preferably have indicia 36 indicating firmness fill levels. There is preferably at least one fluid-filled cell 32 in each chamber 30, but there could be two or more cells in a chamber. The fluid-filled cells 32 can have different fluid fill levels, to selectively provide different levels of support for the overlying slats 28 comprising the mattress surface 24, as explained below in greater detail in reference to FIGS. 10-26. The fluid-filled cells 32 preferably have the same size and shape cross section as the chambers 30 in which they are disposed.

The preferred oval shape of the fluid-filled cells 32 provides a significant portion of the “sub surface” of the mattress to consist of consist of the fluid filled cells. Preferably the cells underlie at least 50% of the subsurface, and in the preferred embodiment underlie about 78% of center portion of the mattress. This helps provide excellent contouring capabilities, particularly under the hip and torso area. By providing fluid-filled cells 20 with a greater horizontal axis greater than vertical axis, the fluid filled cells 32 can comprise a larger portion of the subsurface area without much corresponding weight (when using heavier content fill such as water or gel). This allows for a superior contouring effect without unduly burdening the mattress with excess weight.

The elongate chambers 30 preferably have a generally oval cross section, but they could have a circular or rectangular cross-section as well. The oval cross section of the chamber 30 can be oriented the major axis generally parallel to the top surface 24 of the body 22, or alternatively with the minor axis generally parallel to the top surface. The chamber can open at each end to the sidewall of the body 22. Alternatively one or both ends of the chambers 30 can be closed.

A foam sheet 36 can overly the top surface of the body, and/or a cover (not shown) can extend over at least the top surface of the mattress 20.

The foam body 22 preferably comprises polyurethane foam, but could also be latex foam, gel-filled foams, and various viscoelastic foams (so-called “memory foams”. The foam preferably has a density of between about 0.5 and about 7.0 pounds per ft³, and a firmness of between about 8 IFD and about 70 IFD, as measured according to ASTM D3574. The foam body is preferably a single block of a single material with uniform properties; however the foam body could comprise multiple sections of the same foam with the same properties, the same foam with different properties, or different foams with different properties. These sections could be different layers, or different blocks arranged across the width or length to provide different support

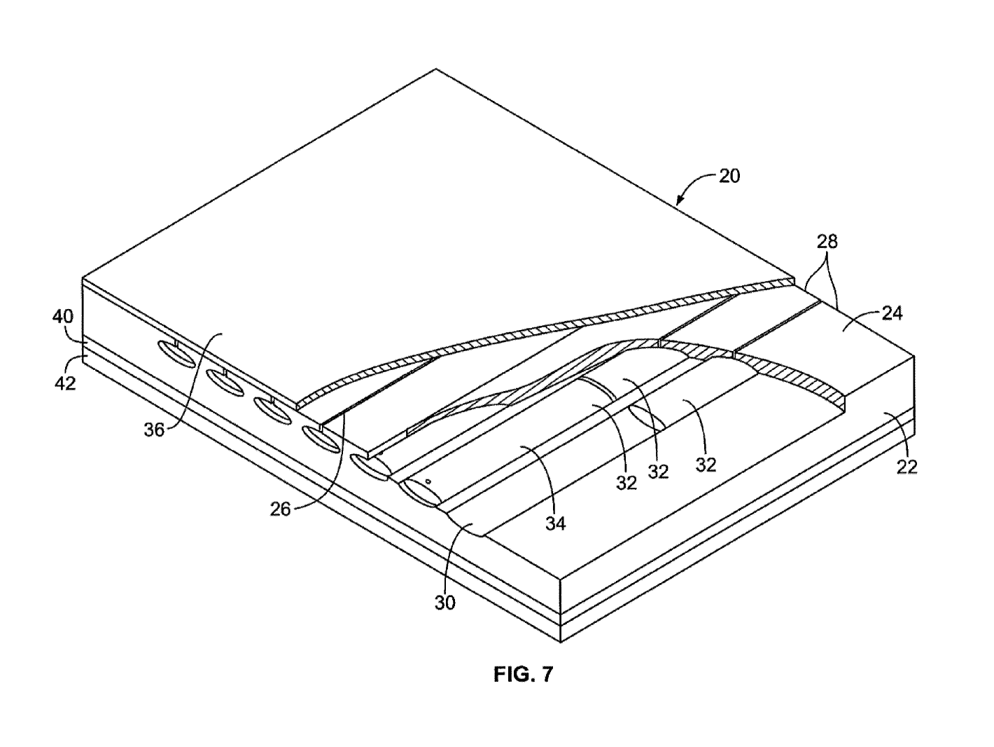

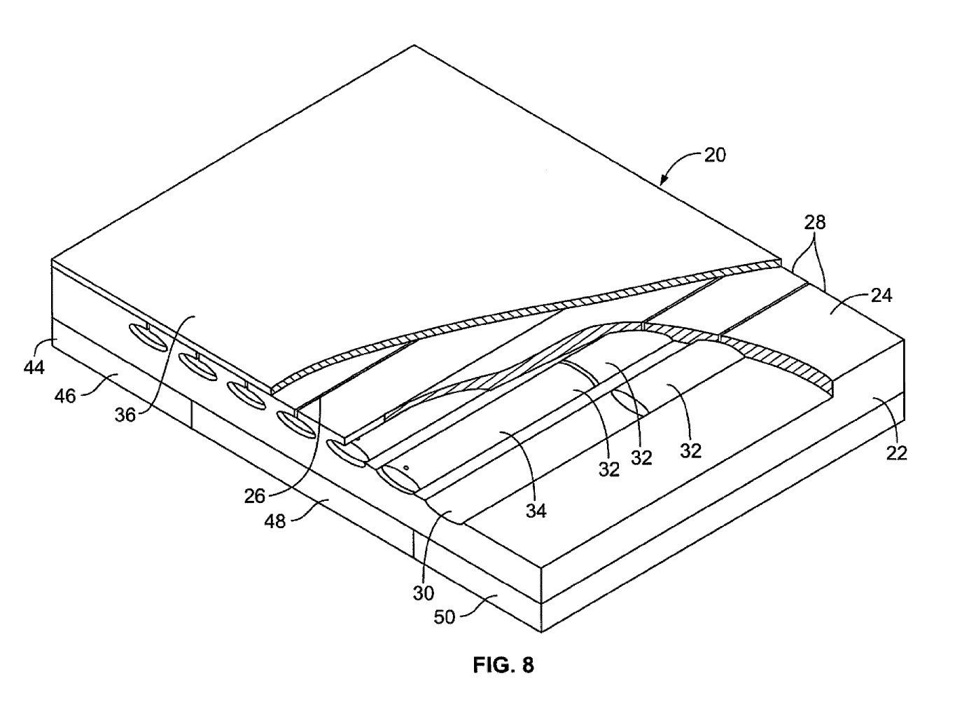

As best shown in FIG. 6, the elongate chambers 30 preferably extend under the ends of adjacent slats 28 so that each slat has generally T-shaped configuration, connected to the body at the stem of the “T”, with the arms of the “T” extending oppositely to adjacent slits. An elongate chamber 30 is disposed on each side of the stem underneath each arm.

In the preferred embodiment the slits 26 are equally spaced to divide the top surface 24 of the body into slats 28 of equal size, although in some embodiments the slits could be unequally spaced to divide the top surface of the mattress into slats of unequal size. In the preferred embodiment there are seven slits defining six slats between them, but there could be fewer or more slits if desired.

In the preferred embodiment, the thickness of each the arms of the generally T-shaped slat tapers from the stem to the end of the arm. The minimum thickness of the stem of the T is less than the distance from the stem to the end of each arm. The width of the cross section of the elongate chamber is less that the width of the T forming the slat. Adjacent elongate chambers underlie at least about 50% of the width of the T forming the slat, but preferably underlie no more than about 75% of the width of the T forming the slat. The minimum thickness of the stem of the T equals the distance from the top surface to the depth where the minimum thickness occurs.

The T-shaped configuration of the slats 28 allows for improved contouring as each foam T structure is allowed to individually articulate/rotate from the head to the foot of the mattress. In some embodiments some or all of the T-shaped slats 28 may be cut into two or more segments to form multiple independently articulating units. For example in some embodiments the slats 28 might be bisected so that the slats on one side of the mattress respond independently of the slats on the other side of the bed. In other embodiments some of the slats may be bisected, for example the slats in the middle portion of the mattress to provide selected areas of independent responsiveness. Of course in still other embodiments some or all of the slats could be divided into more than two segments. In embodiments where the slats are divided into two or more sections, it is generally desirable, but not required, that separate fluid-filled cells 32 be provided in the chambers corresponding to and aligned with each segment. This further enhances the independent action of the slat segments.

The elongate chambers 30 are disposed within the upper half of the thickness of the foam body 22. The width of the cross-section of the elongate chamber is preferably at least two times the height of the cross-section of the elongate chamber, and more preferably at least three times the height of the cross-section of the elongate chamber.

The thickness of the arms at their ends is preferably at least one half of the thickness at the stem. The thickness of the arms at their ends is at least one half of the height of the cross-section of the elongate chamber. The minimum thickness of the stem of the T is preferably less than one third of the width of the top of the T forming the slat.

Table 1 shows the dimensions of the preferred embodiment, although these dimensions can be changed to adjust the properties of the mattress.

| Description | Symbol | Dimension | |
|---|---|---|---|
| Thickness of body | A | 7 | inches |
| Height of chamber | B | 2 | inches |
| Depth of chamber | C | 1 | inch |
| Width of chamber | D | 6 | inches |
| Separation of Chambers | E | 2 | inches |
| Width of the “T” | F | 7.75 | inches |
| Width of the slot | G | 0.25 | inches |
| Distance from bottom of | H | 3 | inches |
| chamber to top of Body | | | |
| Distance from the bottom | I | 4 | inches |
| of the chamber to the | | | |
| bottom of the body | | | |
| Distance from the top | J | 6 | inches |
| of the chamber to the | | | |
| bottom of the body | | | |
| Distance from the midpoint | K | 2 | inches |
| of the chamber to the top | | | |
| Distance from the center | L | 3 | inches |
| of the chamber to the end | | | |

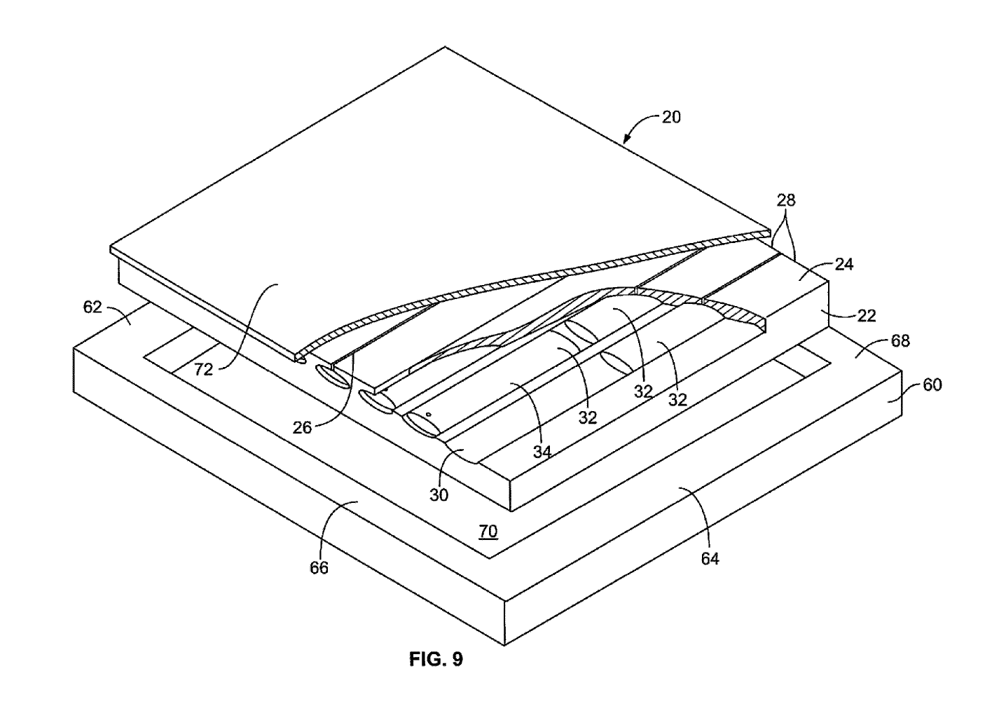

An first alternate construction of the preferred embodiment of a mattress is indicated generally as 20′ in FIG. 7. Mattress 20′ is similar to mattress 20, and corresponding parts are identified with corresponding numbers. However mattress 20′ further includes additional substrates (support layers) 40 and 42. The layer 40 is preferably made of a material, such as a foam, or polystrand material, with a higher IFD (indentation force deflection) or firmness than the rest of the mattress. The layer 42 below the layer 40, is preferably made of a material, such as a foam or polystrand material, with an even higher IFD or firmness than layer 40.

A second alternate construction of the preferred embodiment of a mattress is indicated generally as 20″ in FIG. 8. Mattress 20″ is similar to mattress 20, and corresponding parts are identified with corresponding numbers. However mattress 20″ further includes an additional substrate layer 44. The layer 44 preferably comprises two or more segments. As shown in FIG. 8, the layer 44 comprises sections 46, 48, and 50. Each of the sections is preferable made of a material, such as a foam or a polystrand material, with an appropriate IFD or firmness. For example, section 48 underlying the central portion of the mattress, can have a higher IFD or firmness than sections 46 and 50 underlying the head and foot of the mattress. Sections 46 and 50 can have the same IFD or firmness, or they can have a different IFD or stiffness. While three sections 46, 48, and 50 are shown in FIG. 8, there could be fewer or more sections.

A third alternate construction of the embodiment of a mattress is shown in FIG. 9. As shown in FIG. 9, a mattress according to the principles of the invention, such as mattress 20, 20′, or 20″ is installed in a tray 60. The tray 60 comprises a base with a head wall 62, a foot wall 64, and left and right side walls 66 and 68 that define a generally central recess 70 for receive the mattress 20, 20′ or 20″. The tray 60 can be made of a foam, preferably with a higher IFD or firmness than the mattress so to form a firm edge to facilitate getting into and out of the bed. A comfort layer 72, instead of or in addition to the foam layer 36, can be provided, sized the same as the mattress, and central recess 70 can be made to accommodate both the mattress and the comfort layer. Preferably, however, the comfort layer 72 is sized to overly both the mattress and the tray 60. The comfort layer 72 can also be made of a foam.

The tray helps keep the mattress assembled and protects its components. It can also contain any fluid that leaks from the mattress. The tray 60 can be made of any suitable material including foam, and may be of a closed cell foam or a coated foam to make the tray fluid tight. The tray can be made of a flame resistant material, or coated with a flame resistant material to assist in passing the Consumer Products Safety Commission regulation 1633 mattress flammability test.

To assist a user in selecting, or setting up for use, a mattress of the type described above, a mattress calibration application may be provided. The mattress calibration application allows the user to select and then set the support level of the mattress in a customizable manner based upon user sleep characteristics data. In one embodiment, the mattress calibration application may allow the user to select a mattress of the type described above based upon the user's sleep characteristics and then obtain the mattress calibration data needed for the user for the recommended mattress. In another embodiment the mattress calibration application may allow the user to obtain the mattress calibration data for the user for a selected mattress type. In one embodiment, the mattress calibration data comprises information for the user to set the ideal or recommended air pressure of chambers in an adjustable mattress. In another embodiment, the mattress calibration data comprises information for the user to set the fill each of the fluid filled cells 32 with water (or other fluid) to a level prescribed by the mattress calibration application. In another embodiment, the mattress calibration data may comprise information on foundations, and in particular, information on articulation settings for adjustable foundations. An example of an adjustable foundation is described in U.S. Pat. No. 7,522,062, the disclosure of which is incorporated by reference herein. In accordance with the embodiment of a foundation as described in U.S. Pat. No. 7,522,062, the mattress calibration data may provide information for setting the angle of articulation of the head deck, seat deck, leg deck, and/or foot deck of the foundation. A further description of the mattress calibration application 130 follows below.

FIG. 10 depicts a computing system 100 in accordance with an example embodiment through which a mattress calibration application 130 may be deployed. The computing system 100 may include a server 102, a database 104 for access by the server 102, and the mattress calibration application 130 for execution by a client computer 106. The server 102 and the client computer 106 may communicate with each other via a network 108. Any server computer system capable of performing the operations described herein for the server 102 may serve as server 102. It should be understood that the server 102 may take the form of one or more such suitable servers. The database 104 may take the form of one or more physical memories in which data structures can be stored in a manner suitable for the user sleep characteristic data 140 and the mattress calibration data 150 described herein. The user sleep characteristic data 140 and the mattress calibration data 150 as described herein can be stored as a plurality of data structures within database 104. It should be understood that a data structure is a physical manifestation of information organized within a computing system. Examples of data structures may include data files, records, tables, arrays, trees, objects, and the like. The network 108 may be any network capable of communicating information between computers, including but not limited to wired and wireless networks, the Internet, cellular networks, and any combinations thereof.

The client computer 106 may take the form of any computer capable of communicating with the server 102 via network 108 and presenting the GUIs as described herein. Furthermore, while the example of FIG. 10 shows a single client computer 106 in system 100, large numbers of client computers 106 may access the server 102 via network 108. Examples of client computers 106 may include desktop computers/workstations, tablet computers, and smart phones. The client computer 106 may include a processor 110 in cooperation with a memory 112 and a display 120. The display 120 may be configured to display content 124 as described in more detail below. The client computer 106 may also include a number of other components, such as an input component (e.g., keyboard, mouse, touchscreen, etc.), a network interface component, and others. The client computer 106 may be resident in a retail environment, for instance, a point of display kiosk, or may be remote to the retail environment. The input means may be a keyboard, a “touch screen”, a mouse, or any other device that allows the user to input information. By way of example and not in any limiting way, the input may also be voice activated and information could be received orally. A computer may alternatively comprise one or more standalone PCs on which the calibration software is installed locally. A printer (not shown) may also be provided to allow the purchaser to print the mattress calibration information, the mattress model, comfort index and/or other related mattress information. In a retail environment, the display 120 may comprise a large screen which may be configured to display the GUIs of the mattress calibration application 130. The large screen display may be used to assist in making the sales presentation. The content 124 may include point of sale information, which may be positioned about the large screen display. For instance, a kiosk (not shown) may provide a convenient station to house the large screen display, processor and point of sale information. The kiosk may include the mattress calibration application 130 and may be configured for storing information relating to the consumer. For instance, the mattress calibration application 130 may allow the generation of a personalized report of the consumer's information including his or her sleep characteristics and mattress calibration data, as will be discussed below. The large screen display may be a touch screen graphic user interface thereby eliminating the need for a keyboard. The large screen display may be used in place of the controller or in addition to a separate controller. The system may interface with the retail establishment's inventory control system to provide a consumer with a list of mattresses and sleep accessories in stock corresponding to the user's sleep characteristic data and the mattress calibration data for the corresponding mattresses.

The mattress calibration application 130 may include a user sleep characteristics module 134 and a mattress calibration calculation module 136. The mattress calibration application 132 can take the form of software embodied as a plurality of processor-executable instructions resident on a non-transitory computer-readable storage medium. In an example embodiment, the mattress calibration application 130 can be a web application.

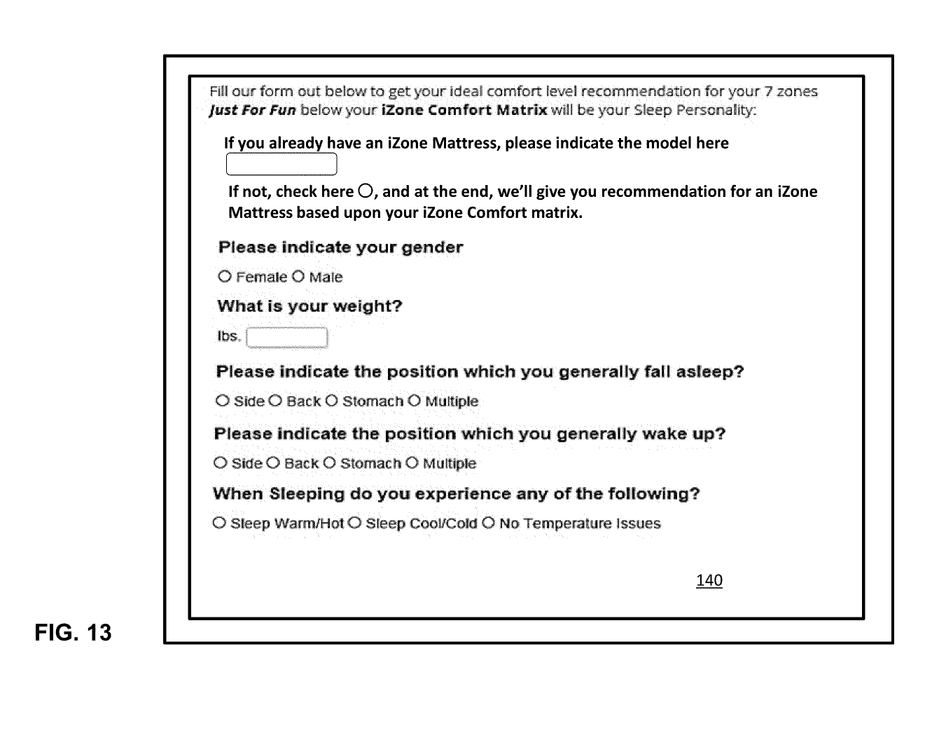

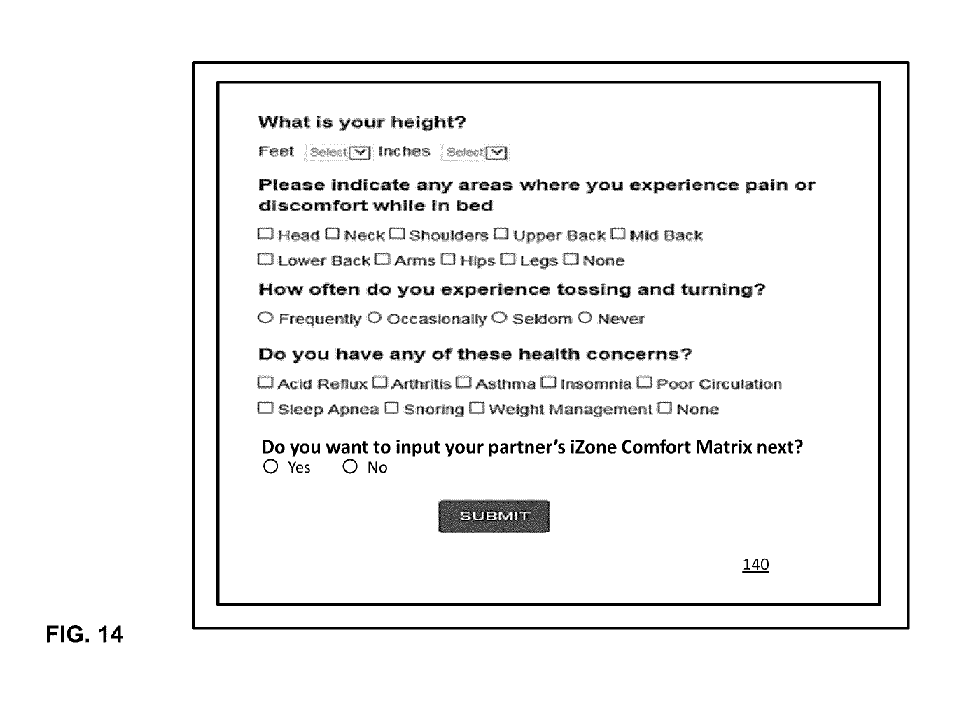

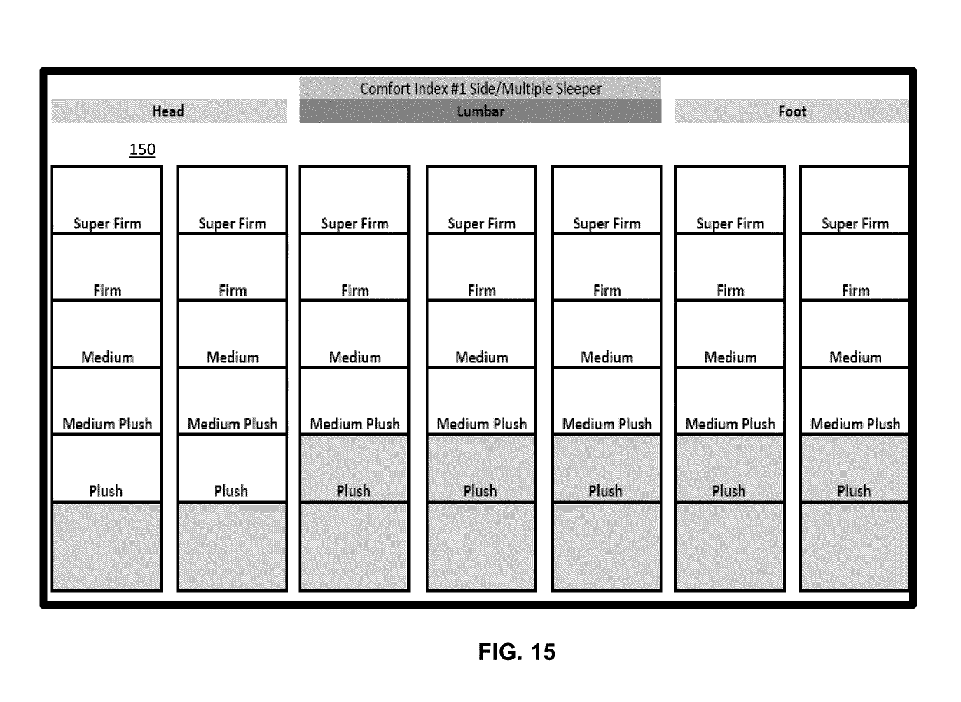

In operation, the example system 100 of FIG. 10 can be operated such that a user of the client computer 106 submits user sleep characteristic data 140 to the server 102 via network 108. FIGS. 13-14 shows GUIs with display configured to allow the user to input user sleep characteristic data 140. Based on the inputted user sleep characteristic data 140, the server 102 interacts with the database 104 to retrieve mattress calibration data 150 of interest for the user. The server 102 then transfers content 124 from its memory to the client computer 106 in response to the user sleep characteristic data input 140. Upon receipt of the content 124, the client computer 106 loads the content 124 into its memory 112. Processor 110 executes the application 132 and interacts with the display screen 120 to cause the display screen to receive the user sleep characteristic data 140 and to present the mattress calibration data 150. An example of mattress calibration data is shown in FIGS. 15-26.

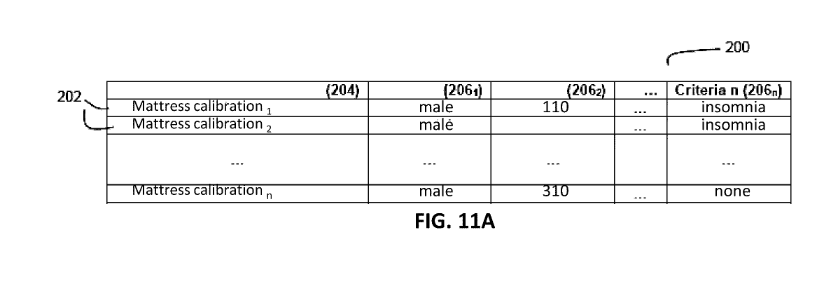

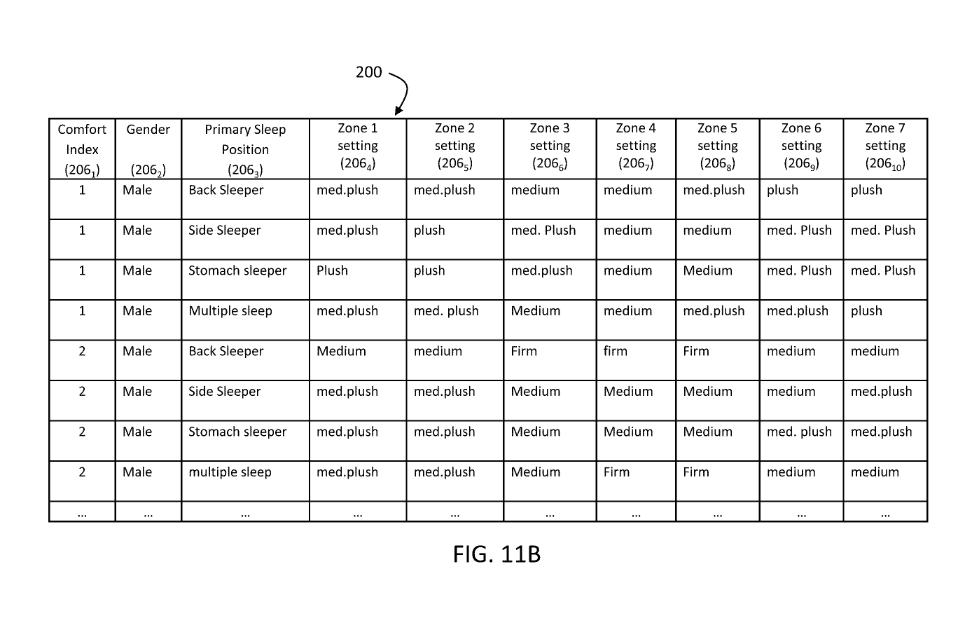

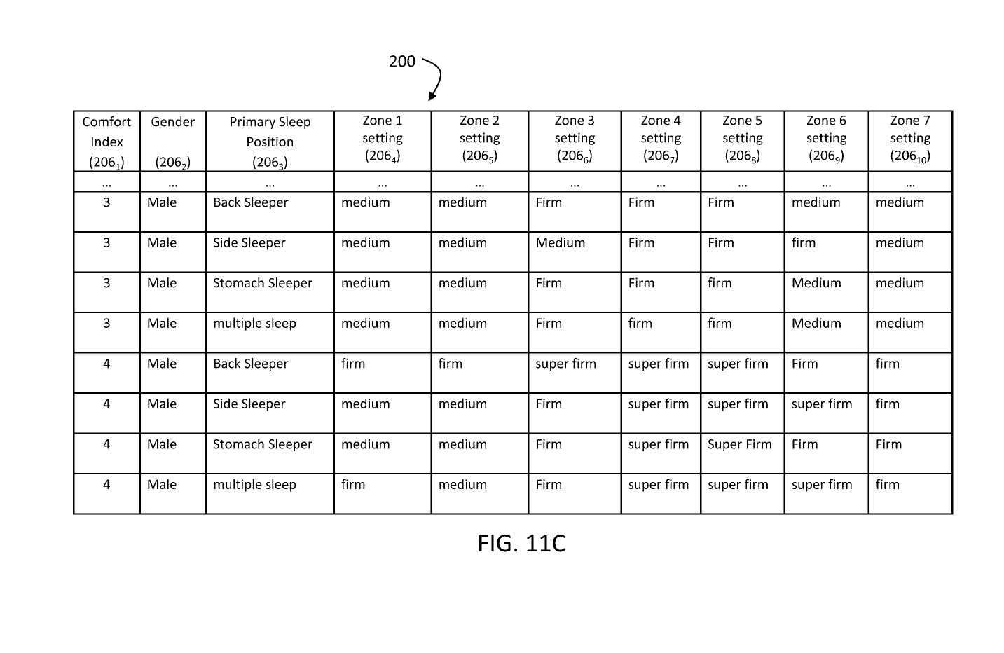

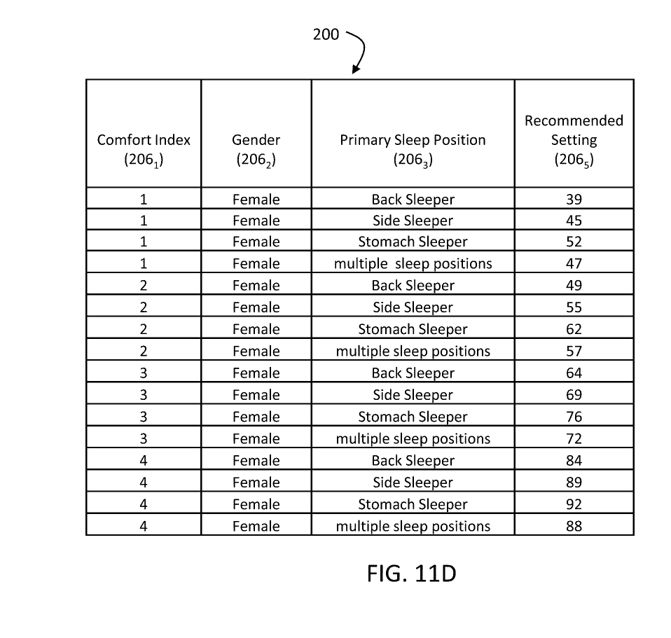

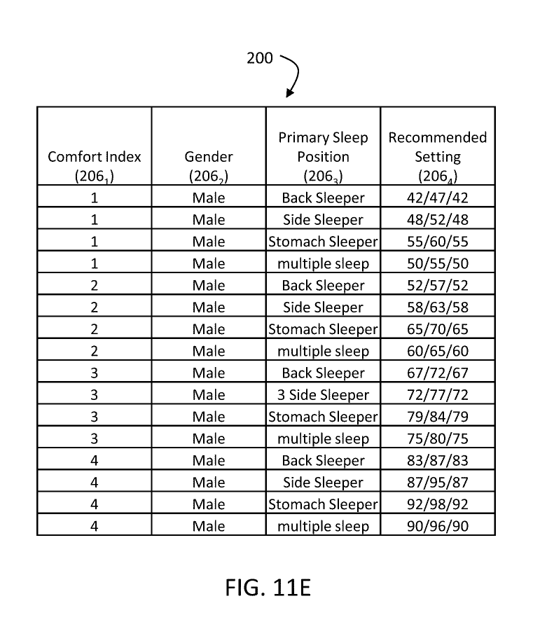

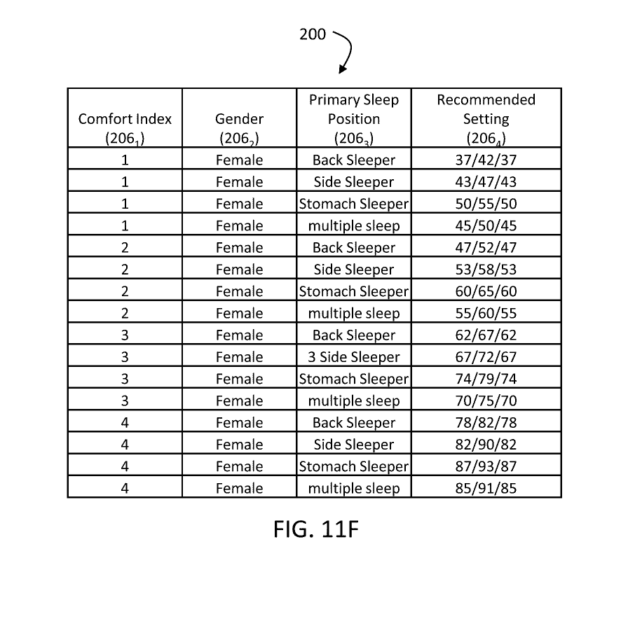

FIGS. 11A-11F show examples data structures 200 for mattress calibration data and user sleep characteristic data that can be present in database 104. While the drawing shows the data structure arranged as a database table, although other data structure arrangements may be used. Each row 202 in the table corresponds to a different mattress calibration, and the mattress calibration data can include a number of associated fields, based upon the user sleep characteristics 206₁, 206₂, . . . 206ₙ. The user sleep characteristic criteria fields 206ᵢ can be populated with criteria data values for the associated mattress calibration data. Examples of criteria that can be associated with criteria fields 206ᵢ may include answers to the user's sleep characteristics as described below. The data structures may also include data related to information on pillows, mattress protectors, foundations, articulation settings for adjustable foundations, mattress pads, mattress toppers, a particular type of sheet set and/or a particular type of comforter.

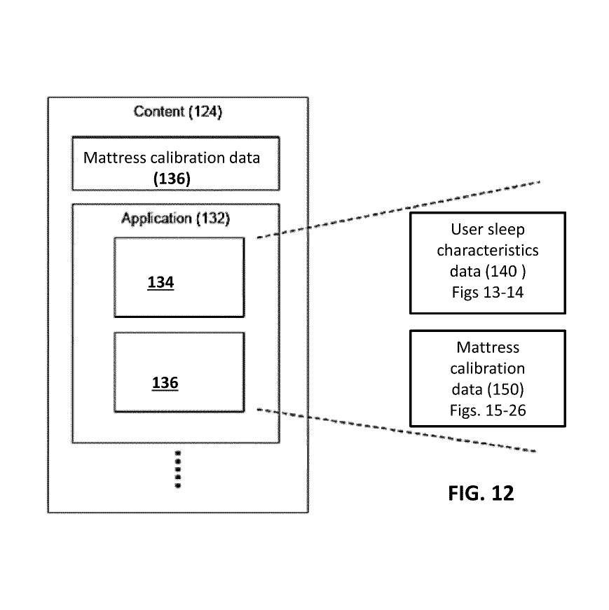

As shown in FIG. 12, the application 130 may include the user sleep characteristic processing module 134 and the mattress calibration calculation module 136 for execution by the client computer 106. The user sleep characteristic processing module 134 and the mattress calibration calculation module 136 can cooperate with each other during execution to generate user sleep characteristic input fields as shown by example in FIGS. 13-14, and mattress calibration data for display such as the example shown by FIGS. 15-26. The user sleep characteristic processing module 134 can cause the display of the user sleep characteristic input fields through the GUI and can be configured to arrange the user sleep characteristics data in a form for use in the database table. The mattress calibration calculation module 136 can be configured to calculate and cause the display of the mattress calibration data through the GUI.

FIGS. 13-28 depict example embodiments regarding various features that may be included in the GUIs that present the user sleep characteristic input data fields and the mattress calibration data to users. For instance, FIGS. 13-14 show example embodiments of the user sleep characteristic input data fields. The mattress calibration application may be configured to present GUI's with any of the following questions:

Please indicated the model of mattress?

Open field for mattress type

Check here for a recommended mattress type

Radio button.

What is your gender?

Radio buttons for “Male, Female”

What is your weight?

Open field input box for weight

What is your height?

Open field input box for height in feet and inches.

Sleep Patterns

Please indicate the position which you generally fall sleep?

Radio buttons for “Side, Back, Stomach, Multiple”

Please indicate the position which you generally wake up?

Radio buttons for “Side, Back, Stomach, Multiple”

When sleeping do you experience any of the following?

Radio buttons for “Sleep Warm/Hot, Sleep Cool/Cold, No temperature issues”

How often do you experience tossing and turning?

Radio buttons for “Frequently, Occasionally, Seldom, Never”

Health Concerns

Please indicate any areas where you experience pain or discomfort while in bed?

Radio buttons for “Head, Neck, Shoulders, Upper Back, Mid-Back, Lower-Back Arms, Hips, Legs, None”

Do you have any of these health concerns?

Radio buttons for “Acid Reflux, Arthritis, Asthma, Insomnia, Poor Circulation, Sleep Apnea, Snoring, Weight Management, None”

Thereafter, the mattress calibration application 132 may be configured to display the content 124 comprising the mattress calibration data 150. By way of example, the mattress calibration data may include information for filling each of the fluid filled cells 32. The mattress calibration data 150 may include data for filling the fluid filled cells 32 of certain zones of the mattress, for instance, the head zone, the lumbar zone, the foot zone. The mattress calibration data 150 may include data for filling the fluid filled cells 32 of one side of the mattress and data for filling the fluid filled cells on the opposite side of the mattress, for instance, for a user and the user's sleep partner. The mattress calibration data 150 may include a combination of data for filling the fluid filled cells corresponding to both partners and to each partner's respective zones. The mattress calibration data 150 may include data relating to a recommended mattress for the user and/or the user's sleep partner. The content 124 comprising the mattress calibration data 150 may comprise graphics showing the user the recommended fill level of each fluid filled cell 32. The graphics may include numerical fill levels, for instance, a scale of 1 to 10 with 1 representing very “plush” and 10 representing very “firm.” The graphics may correspond to graduations on the fluid filled cells. A more qualitive format may also be used with categories such as “plush,” “medium plush,” “medium,” “firm,” and “super firm,” for instance as shown in FIGS. 15-26. Numerical representations of the settings, and settings for zones of the mattress, for each user's side of the mattress, may be shown graphically and with instructions for operation, for instance, as shown in FIGS. 27-28. Depending upon user input and/or the nature of the bed, for instance, double, queen, king size, the mattress calibration application may be configured to re-present the GUIs of FIGS. 13-28 to allow the user's sleep partner to input the user's sleep partner's sleep characteristic data 140 and receive mattress calibration data 150 for the user's sleep partner. In another embodiment, the mattress calibration application allows for printing of a document having the recommended mattress calibration data 150 for the user and/or the user's partner. In one embodiment, the mattress calibration application 130 may be configured to allow storing of a user's mattress calibration data as a “personal profile,” thereby allowing the user to retrieve, modify, or update their “personal profile,” as necessary.

In addition or alternative to the embodiments described herein, the mattress calibration application 130 may be configured to identify one or more mattress models that meet the user's particular needs based upon the user sleep characteristic data 140 and display the same in connection with the mattress calibration data 150. In addition or alternative to the embodiments described herein, the mattress calibration application may provide a prospective purchaser with at least one or more recommended substitute mattress models in the event his or her recommended mattress model is not available, and corresponding pricing information to assist the purchaser in his or her purchasing decision. In addition or alternative to the embodiments described herein, the mattress calibration application may provide a prospective purchaser with recommend sleep aids and/or settings therefor. For instance, the mattress calibration application may be configured to provide information on pillows, mattress protectors, mattress pads, mattress toppers, a particular type of sheet set and/or a particular type of comforter that is compatible with the mattress calibration data and based upon the user's sleep characteristic data. In addition or alternative to the embodiments described herein, the mattress calibration application may be configured to provide information on foundations compatible with the mattress calibration data and based upon the user's sleep characteristic data. The foundation information may include information on articulation settings for adjusting the foundation including information for setting the angle of articulation of the sections of the foundation. In addition or alternative to the embodiments described herein, the mattress calibration application 130 may interface with a retail establishment's order entry system allowing the user to purchase a mattress through the mattress calibration application.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for calibrating a mattress, wherein the mattress has at least one fluid filled cell configured to in part provide recommended support for the mattress, the system comprising:
a database, the database comprising data about support characteristics of the mattress depending upon an amount of fluid contained in the at least one fluid filled cell;
a server for communication with the database and for communication with a client computer via a network, wherein the server includes a memory in which an application is stored; and
the application configured for execution by the client computer, wherein the application comprises a (1) user sleep characteristic processing module, and (2) a mattress calibration calculation module;
wherein the server is configured to (1) communicate the application to the client computer via the network, (2) receive user sleep characteristic data from the client computer via the network, and (3) based on the received user sleep characteristic data, (i) access the database to retrieve mattress calibration data for the user, and (ii) communicate the retrieved mattress calibration data to the client computer via the network; and
wherein the application is configured, upon execution by the client computer, to (1) generate, via the user sleep characteristics processing module, user sleep characteristics for the user, and (2) render, via the mattress calibration calculation module, mattress calibration data for display on a display screen of the client computer.

2. The system of claim 1 wherein the mattress calibration data includes data for filling the at least one fluid filled cell of the mattress.

3. The system of claim 1 wherein the mattress calibration data includes data for filling the at least one fluid filled cell of a zone of the mattress.

4. The system of claim 1 wherein the mattress calibration data includes data based upon two users' sleep characteristics.

5. The system of claim 1 wherein the mattress calibration data includes data representative of a recommended mattress.

6. The system of claim 5, where the application further comprises programming configured to place an order for purchase of a recommended mattress upon initiation by the client computer.

7. The system of claim 1 wherein the application is configured for execution through a browser of the client computer.

8. The system of claim 1 further comprising the client computer.

9. The system of claim 1 wherein the mattress calibration data includes data representative of at least one of a foundation, a setting for an adjustable foundation, a pillow, a mattress protector, a mattress pad, a mattress topper, a sheet set, and a comforter.

10. The system of claim 1, wherein the fluid filled cell is configured to contain water.

11. A method comprising:
providing a computer system having a user interface and a database configured to store data relating to a mattress, wherein the mattress has at least one fluid filled cell configured to in part provide recommended support for the mattress;
receiving sleep characteristic data associated with a user via the user interface;
correlating the user sleep characteristic data to the mattress data stored in the database; and
determining a recommended fill level for the at least one fluid filled cell based upon the correlation of the mattress data stored in the database and the user's sleep characteristic data.

12. The method of claim 11 wherein the user sleep characteristic data comprises at least one of the user's sleep patterns, the user's health concerns, the user's height, the user's gender, and the user's weight.

13. The method of claim 11 wherein the step of receiving the user sleep characteristics comprises generating a plurality of questions determinative of the user's sleep characteristics to be displayed and answered via the user interface.

14. The method of claim 11, further comprising generating a recommended mattress type.

15. The method of claim 11 where the step of determining the recommended fill level for the at least one fluid filled cell based upon the correlation of the mattress data stored in the database to the user's sleep characteristic data includes providing user instructions for filling the at least one fluid filled cell of the mattress.

16. The method of claim 15 wherein the step of determining the recommended fill level for the at least one fluid filled cell based upon the correlation of the mattress data stored in the database to the user's sleep characteristic data includes providing user instructions for filling the at least one fluid filled cells for a specified zone of the mattress.

17. The method of claim 11 further comprising determining a recommended fill level for at least one other fluid filled cell of the mattress based upon a correlation of the mattress data stored in the database to a second user's sleep characteristic data.

18. The method of claim 11, further comprising providing the computer system with programming configured allow the user to place an order for purchase of a recommended mattress upon initiation by the client computer.

19. The method of claim 11 further comprising determining at least one of the following based upon the correlation of the mattress data stored in the database and the user's sleep characteristic data: a foundation, a setting for an adjustable foundation, a pillow, a mattress protector, a mattress pad, a mattress topper, a sheet set, and a comforter.

20. The method of claim 11, wherein the fluid filled cell is configured to contain water.

21. A method comprising:
providing a server configured for communication with a database having stored therein data about support characteristics of a mattress, wherein the mattress has at least one fluid filled cell configured in part to provide recommended support for the mattress; and wherein the mattress support characteristics data relates to the support characteristics of the mattress depending upon an amount of fluid contained in the at least one fluid filled cell; and wherein the server is configured for communication with a client computer via a network; and
providing an application stored in a memory of the server; wherein the application is configured for execution by the client computer; and wherein the application comprises: (i) a user sleep characteristic processing module, and (ii) a mattress calibration calculation module;
wherein the server is configured to (a) communicate the application to the client computer via the network, (b) receive user sleep characteristic data from the client computer via the network, and (c) based on the received user sleep characteristic data, (I) access the database to retrieve mattress calibration data for the user, and (II) communicate the retrieved mattress calibration data to the client computer via the network; and
wherein the application is configured, upon execution by the client computer, to (a) generate, via the user sleep characteristics processing module, user sleep characteristics for the user, and (b) render, via the mattress calibration calculation module, mattress calibration data for display on a display screen of the client computer.

22. The method of claim 21 further comprising providing the mattress calibration data with data for filling the at least one fluid filled cell of the mattress.

23. The method of claim 21 further comprising providing the mattress calibration data with data for filling the at least one fluid filled cell of a zone of the mattress.

24. The method of claim 21 further comprising providing the mattress calibration data with data based upon two users' sleep characteristics.

25. The method of claim 21 further comprising providing the mattress calibration data with data representative of a recommended mattress.

26. The method of claim 21 further comprising providing the application with programming configured to enable placing an order for purchase of a recommended mattress upon initiation by the client computer.

27. The method of claim 21 further comprising providing the mattress calibration data with data representative of at least one of the following: a foundation, a setting for an adjustable foundation, a pillow, a mattress protector, a mattress pad, a mattress topper, a sheet set, and a comforter.

28. The method of claim 21, wherein the fluid filled cell is configured to contain water.
